(19) United States
(12) Patent Application Publication
(10) Pub. No.: US 2019/0360940 A1
(43) Pub. Date: Nov. 28, 2019

(54) Method and System for Detecting Abnormalities in Coated Substrates

(71) Applicant: Grey Gecko LLC, Newport News, VA (US)

(72) Inventors: Austin Ziltz, Williamsburg, VA (US); Keith Reed, Newport News, VA (US)

(21) Appl. No.: 15/986,660

(22) Filed: May 22, 2018

(51) Int. Cl. G01N 21/88; H04N 5/225

(52) U.S. Cl. CPC G01N 21/8806; H04N 5/2252; G01N 2021/8848; G01N 2021/8835; H04N 5/2256

(57) ABSTRACT

Provided is a system for detecting abnormalities in underlying surface of a coated substrate that includes a housing blocking external sources of light from impinging on the coated substrate; an array of light sources, matched in bandwidth to the transmission spectrum of the coating, arranged to direct light upon the coated substrate; an optical imaging system matched to the wavelength range of the light source array and positioned to collect reflected and scattered light from the substrate and generate an image of the structural features including any abnormalities in the substrate; and an onboard embedded system, providing real-time image processing to correct spatial and temporal variations in the light source array intensity and optical imaging system sensitivity. The optical imaging system includes a focal plane array matched in bandwidth to the transmission spectrum of the coating, and a flat optical window configured to reduce the optical Narcissus effect.

### I. CROSS REFERENCE

This application is a non-provisional application claiming priority to Provisional Application Ser. No. 62/509,621 filed on May 22, 2017, the contents of which is incorporated herein in its entirety

### II. TECHNICAL FIELD

The present invention relates generally to a method detecting abnormalities in coated substrates. More particularly, the present invention relates to a method and system for detecting abnormalities on the surfaces directly below the coating.

### III. BACKGROUND

Structures such as buildings, automobiles, marine vehicles and aircrafts are typically coated for preventative and aesthetic purposes and experience degradation based on environmental conditions. The environmental conditions can include rain, high winds, humidity, heat and salt spray, and other conditions which can potentially cause external and internal damages to the substrates of the structures. Some problems detected include corrosion, mold, cracks, scratches, delamination, and material fatigue, for example.

Conventional methods of detecting these abnormalities include visual inspection, x-ray, eddy current and capacitance point measurements or heating the substrate to generate infrared light for detection of any abnormalities of the substrate.

### IV. SUMMARY OF THE EMBODIMENTS

Given the aforementioned deficiencies, a system for detecting abnormalities in underlying surface of a coated substrate that includes a housing formed to block external sources of light from impinging on the coated substrate; an array of light sources, matched in bandwidth to the transmission spectrum of the coating, arranged to direct light upon the coated substrate; an optical imaging system matched to the wavelength range of the light source array and positioned to collect reflected and scattered light from the substrate and generate an image of the structural features including any abnormalities in the substrate; and an on-board embedded system, providing real-time image processing to correct spatial and temporal variations in the light source array intensity and optical imaging system sensitivity.

According to one or more embodiments, a detection software module is accessed via the embedded system in communication with the optical imaging system.

Further, according to one or more embodiments a wearable head-up display (HUD) is in communication with the embedded system to remotely view output and status of the detection system.

The communication performed within the system can be performed via wireless communication or wired communication.

According to yet another embodiment a detection method implemented by the above-identified system is provided.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### V. DESCRIPTION OF THE DRAWINGS

FIG. 1 is a block diagram illustrating the detection system according to one or more embodiments.

FIG. 2 is a schematic illustrating the detection system and detection method according to one or more embodiments of the present invention.

FIG. 3 is a schematic illustrating the detection system and detection method according to one or more alternative embodiments of the present invention.

FIGS. 4A, 4B and 4C illustrates various applications of the detection system according to one or more embodiments.

FIG. 5 illustrates a flow diagram showing a detection method of the detection system of FIGS. 1 through 4 that can be implemented according to one or more embodiments.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### VI. DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components.

In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

As noted above, embodiments of the present invention include a detection system and a detection method thereof, including an optical imaging system and light source array to capture video data stream of an underlying surface of a coated substrate in order to detect any abnormalities such as corrosion, cracks, scratches, delamination, and material fatigue. The system is capable of detection damage before it has compromised structural integrity of the substrate or coating. The system is also capable of identifying hidden fasteners, structural feature locations, reading obscured/embedded codes or part numbers (e.g., serial numbers), inspecting composite substrates for damage, revealing previously repairs substrates, and identifying weakened/thinned regions of coatings which needs to be replaced/repaired.

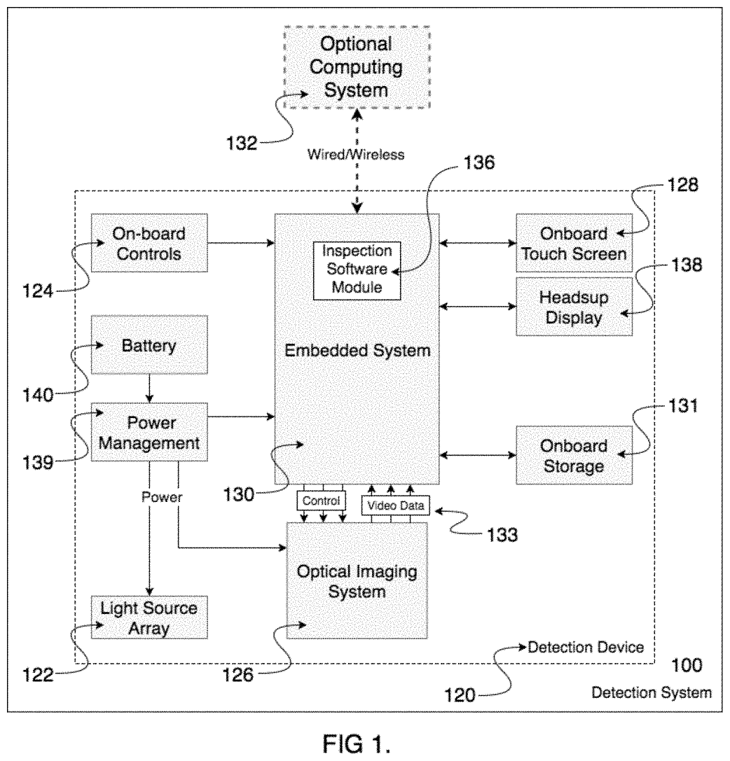

FIG. 1 is a block diagram illustrating the detection system 100 according to one or more embodiments. The detection system 100 includes a light source array 122, onboard controls 124 and optical imaging system 126 in communication with an embedded system 130. The onboard controls 124 provide functions such as on/off function of the system 126, the light source array 122 and the onboard video display 128. In addition, the onboard controls 124 provide the function of obtaining still images from the video data stream 133. The onboard controls 124 connect to the embedded system 130 to adjust light source array intensity, and provide control signals to the other components of the system 100 and receive remote input from an external computing device 132 discussed below. According to an embodiment, the optional computing device 132 can be a tablet, laptop or a desktop computer.

The optical imaging system 126 and the embedded system 130 communicate directly. The embedded system 130 controls the optical imaging system 126 and the light source array 122. The digital video data stream 133 from the optical imaging system 126 is processed in real-time and corrected for known spatial intensity variations of the light source array 122; spatial and temporal variations in the optical imaging system 136 sensitivity; and the optical Narcissus effect that occurs when an infrared optical imaging system 136 is used.

According to one or more embodiments, the system 100 further includes an a detection software module 136 (e.g., an inspection software application) accessible by locally via the embedded system 130 and remotely through the optional external computing device 132. The embedded system 130 and optional external computing device 132 are configured to process, display and store information and image data in real-time, record location, automate reporting, maintain a database (not shown) of the information and image data, store the detection instructions of the detection software module, and communication with external components (e.g., other hardware, servers, and networked inspection tools). The embedded system features onboard storage 131. The database can include images of previous inspections and examples of hidden damage data for comparison with new image data obtained by the camera.

The embedded system 130 transmits detection instructions from the detection software module 136 to components of the detection device 120. Alternatively, instructions of the detection software module 136 can be wirelessly transmitted via a wireless communication network (e.g., Wi-Fi or Bluetooth) from the optional external computing device 132. Other wireless networks such as 802.11, 802.15 and cellular networks can also be applicable.

The digital video data stream 133 is displayed in real-time and allows for real-time image processing.

Further, according to one or more embodiments a wearable head-up display (HUD) 138 is in communication with the embedded system 130 to transmit information to the wearable HUD 138. The communication performed within the system 100 can be performed via wireless communication or wired communication.

The wearable HUD 138 is an optional component which can be employed to further enhance the detection method by allowing an operator to view what the detection device sees, while remaining out of local or line-of-sight contact. An operator of the detection device 120 can wear the HUD 138 which receives the processed video stream from the embedded system 130. Further, the HUD 138 can include onboard controls similar to the onboard controls 124 of the detection device 120, to control the detection software module 136, and the device 120 to increase/decrease light source array intensity, save images, power up/down, for example. Thus, the same control operations performed at the detection device 120 can also be performed at the HUD 138.

The system 100 further includes a power management system 139 and a battery 140 (e.g., an onboard replaceable or rechargeable battery). The battery 140 is hot-swappable and can be configured for extended runtimes (e.g., approximately 3 hours when the system is implemented as a handheld device). The battery status can be monitored via the detection software module 136. Alternatively, when implemented within a larger device, an onboard or belt clip type battery can be used for extended runtimes of approximately 4-5+ hours.

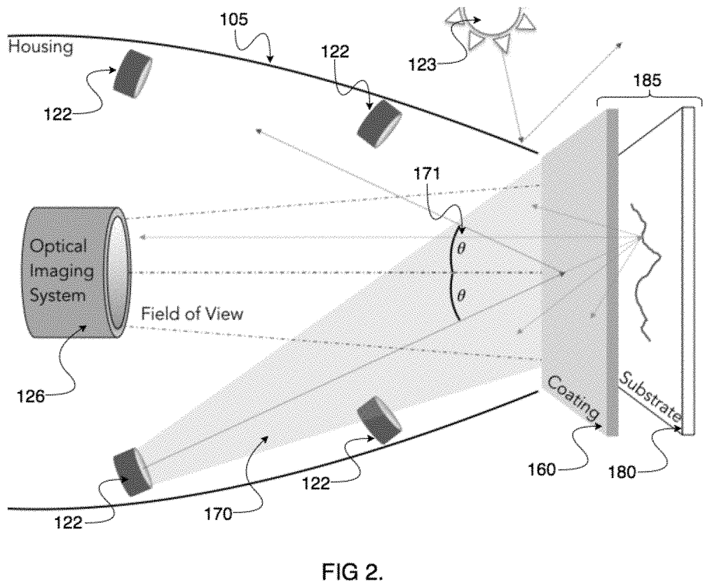

Upon using the detection device 120, the operator can determine how well the coating transparent light 170 from the light source array 122 is penetrating the coating 160 of the coated substrate 185 (as depicted in FIG. 2, for example). Thicker coatings result in less light returning, thus in this case, more light sources can be implemented for better detection.

FIG. 2 is a schematic illustrating the detection device 120 and detection method according to one or more embodiments of the present invention.

As shown in FIG. 2, the detection device 120 includes a housing 105 that is shaped to block all external light sources 123 from impinging on the area of coated substrate 185 to be inspected and encases a light source array 122, and an optical imaging system 126. One or more embodiments of the present invention specifies a mid-wave infrared (MWIR) optical imaging system 126 and light source array 122 for performing the detection method on commercial and military aircraft coatings and substrates. The present invention is not limited to the MWIR ranges (commonly accepted as approximately 2-8 microns) and any other suitable technology can be implemented herein. According to one or more embodiments, the optical imaging system 126 and light source array 122 can be changed to accommodate different transmission properties of coatings 160 or combined with multiple sources to generate images in several bandwidths. For example, the optical imaging system 126 and light source array 122 can be exchanged or combined with components designed for other wavelength ranges such as LWIR (e.g., approximately 8-15 micron wavelength) or SWIR (e.g., approximately 1.4-3 micron wavelength), near infrared (e.g., 0.7-1.4 micron wavelength), or near ultraviolet (e.g., approximately 300-400 nanometer wavelength) such that the detection device 120 can be compatible with a wide range of coatings 160 and the detection device 120 can be implemented within a larger instrument or an instrument with swappable modules configured for different wavelength ranges. Most coatings of interest are intended to be opaque in the visible light spectrum, however extremely narrow transmission windows do exist in the visible spectrum of some coatings, and thus the system described is a viable approach as high-efficiency, narrow band light sources in the visible spectrum are common.

According to an embodiment of the present invention, the optical imaging system 126 has an integrated heat sink and a small fan to be used to pull cool air through the housing 105. According to one or more embodiments, the housing 105 is configured to block and eliminate all external light sources 123 to minimize unwanted light interference and ensure a high signal-to-noise ratio in the detected video data stream. The housing 105 is constructed such that the front edge which contacts the coated substrate is of a non-marring or rubberized material.

As shown, the light source array 122 is positioned at angle of incidence theta to cast coating transparent light 170 onto the coated substrate 185 while avoiding direct reflections (at angle of reflection θ 171) back into the optical imaging system 126. Light is reflected and scattered from underlying surface 180 (e.g., substructure) of the coated substrate 185 and collected by the optical imaging system 126.

According to other embodiments of the present invention, additional spectral filter(s) can be used to decrease the imaging bandwidth depending on the transmission properties of the target coating of the coated substrate 185. That is, if the transmission window is narrow than usual and there is too much reflected light, the bandwidth of detection can be narrowed by the spectral filter(s).

According to other embodiments of the present invention, optical polarizer(s) can be employed to decrease the amount of unwanted reflected light or increase the signal-to-noise of scattered light from underlying artifacts.

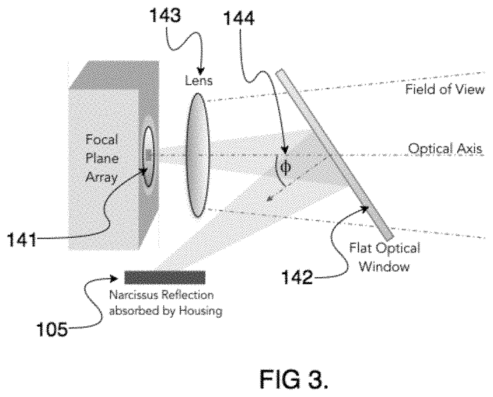

FIG. 3 is a schematic illustrating the optical imaging system 126 according to one or more embodiments of the present inventions.

As shown in FIG. 3, the optical imaging system comprises a focal plane array 141; an imaging lens 143 and an optional flat optical window 142. The focal plane array 141 can be a cryogenically-cooled focal plane array. The lens 143 is positioned via mechanical or electromechanical methods to receive the reflected and scattered light from the underlying surface 180 and produce an image on the focal plane array 141. According to one embodiment, an OEM MWIR camera core is employed as the focal plane array 141 and is matched to the wavelength range a MWIR light source array 122. An infrared focal plane array is often cooled, and thus very cold and will detect a self-generated ghost image of the sensor array retro-reflected from planar surfaces normal to the optical axis. This appears as a central dark spot in close-up optical images known as the optical Narcissus effect.

According to an embodiment, the flat optical window 142 is a Sapphire optic that minimizes the optical Narcissus effect caused by the cooled focal plan array's ghost image retro-reflecting off the coating 160 and substrate 180. The flat optical window 142 is positioned at angle ϕ 144 to direct the self-generated ghost image of the cooled focal plane array 141 away, where it can be safely absorbed by the housing 105. Sapphire is chosen for better transmission to the MWIR wavelengths. The present invention however is not limited to employing a Sapphire window, and any suitable type of flat optical window 142 can be employed. Performance of the flat optical window 142 can be further enhanced through the use of anti-reflection thin film coatings on the optic. Optionally, filters can be added or integrated into the optical components (122, 126, 141, 142, 143) of the detection system 100 to further restrict the bandwidth and increase performance in narrow transmission spectra windows in various coatings.

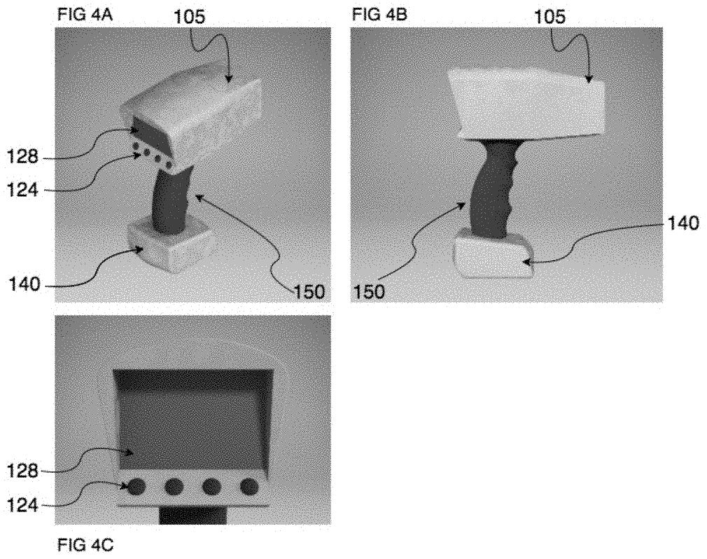

FIGS. 4A, 4B and 4C illustrates various applications of the detection system 100 according to one or more embodiments. As shown in FIGS. 4A, 4B, and 4C, the detection system 100 can be implemented via a handheld device with an integrated or removable pistol grip 150, or a camcorder-style hand strap 151. FIGS. 4A, 4B and 4C depict an embodiment where the detection system 100 is configured with onboard controls 124, a removable pistol-style grip 150 and a removable battery 140. Using the same control structure, detection software module 136 and HUD 138, the detection system 100 can be deployed across a scalable platform of applications. The detection system 100 can be implemented within ground-based autonomous, vehicles (flying or crawling drones), robotic arms, sealed in a water-proof housing to be used in underwater applications, or tripod-mounted as a stand-off device.

According to one embodiment, the system 100 can be implemented as a handheld device 150 which is lightweight, rugged and battery-powered.

The light source array 122 and optical imaging system 126 are removable from the handheld device 150. The handheld device 150 is held right up to the surface of the coated substrate 185 to perform the detection. The camera 126 has a usable depth of field of approximately 1 inch and allows curved and irregular surfaces to remain in focus. If the lens 143 is mounted electromechanically, the focus of the optical imaging system 136 can be optimized by the operator for better performance in off-design geometry applications.

Alternatively, the light source array 122 and optical imaging system 126 can be integrated within a standoff or quad-copter-style gimbal mount for remote operation and inspection.

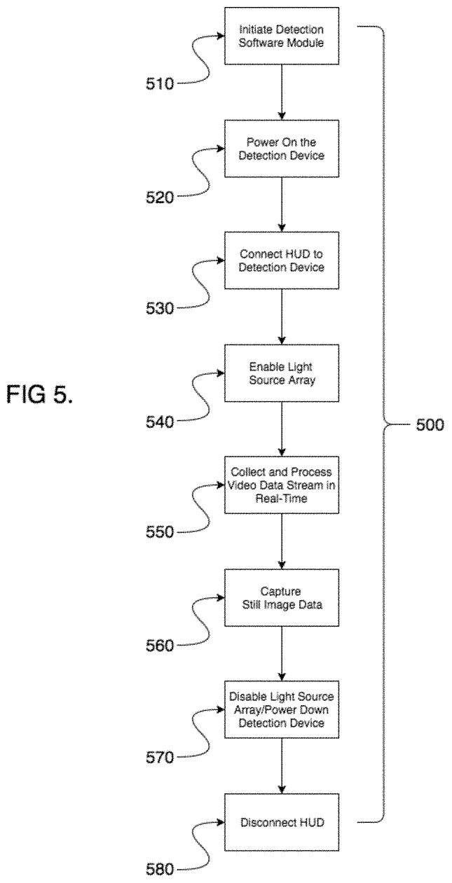

The detection method 500 of the present invention will now be discussed with reference to FIGS. 1, 2 and 3. All detection system 100 operations described herein can be accomplished via the onboard controls 124 or the optional external computing system 132. As shown in FIG. 5, the detection method 500 includes initiating the detection software module 136 (operation 510), powering up the detection device 120 and the optical imaging system 126 (operation 520). Optionally, the method further includes connecting the HUD 138 to the detection device 120, to view the real-time video data stream 133 hands free if desired (operation 530). Next, the light source array 122 is enabled (operation 540) and the system 100 collects and processes the video data stream 133 in real-time (operation 550). Then, data is captured using the onboard controls 124 or the remote peripherals (HUD 138 or external computing system 132) (operation 560). Additionally, descriptive data e.g., location and comments etc. can be added using the above methods during the process.

According to an embodiment, the information can be prefilled or based on repair and inspection requests, for example, stored within the detection software module 136.

The information obtained can be transmitted in real-time to a facility network or at a later time.

Upon completion of the detection method, the optical imaging system 126 and light source array 122 are disabled (operation 570), the detection device 120 is powered down, and the HUD 138 if employed is disconnected (operation 580).

This written description uses examples to disclose the invention including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1-20. (canceled)

21. A system for detecting abnormalities in the underlying surface of a coated substrate, comprising:
an optical imaging system;
a housing shaped to block external sources of light;
a light source array; and
an onboard embedded system providing real-time processing.

22. The system of claim 20, wherein a spectral bandwidth of the optical imaging system is matched to a transmission spectrum of the coating and the optical imaging system is configured to focus on a surface plane of the coated substrate.

23. The system of claim 20, where the housing is shaped to block external sources of light from impinging on a section of coated substrate under inspection, within a field of view of the optical imaging system.

24. The system of claim 20, where a spectral bandwidth of the light source array is matched to a transmission spectrum of the coating, arranged about an interior of the housing to direct light upon the coated substrate within a field of view of the optical imaging system.

25. The system of claim 24, wherein the light source array is configured to avoid direct reflections off the coated substrate into the optical imaging system by ensuring shallow angles of incidence to the coated substrate.

26. The system of claim 25, wherein the light source array is configured to minimize power requirements, maximize intensity and homogenize spatial variations through the use of any one of intensity modulation, a plurality of diffusers, a plurality of polarizers, and curved reflectors.

27. The system of claim 21, further comprising:
onboard controls;
a battery and power management system comprising an onboard battery;
wired and wireless communication hardware; and
on- and off-board peripherals including:
a touchscreen;
a wearable heads-up display (HUD); and
led-indicators,
wherein the onboard embedded system provides real-time image processing to correct spatial and temporal variations in an intensity of the light source array and in sensitivity of the optical imaging system, wherein the onboard embedding system comprises an microcontroller configured to control and power to: the optical imaging system; the light source array; the onboard controls; the battery and power management system comprising an onboard battery; the wired and wireless communication hardware; and the on- and off-board peripherals.

28. The system of claim 27, wherein the embedded system captures a digital video data stream from the optical imaging system and performs real-time image processing algorithms, including:
correction for light source array spatial intensity;
correction for optical imaging system spatial sensitivity;
correction of a Narcissus effect self-generated by the optical imaging system;
edge detection;
feature identification and highlighting; and
false color rendering.

29. The system of claim 27, wherein the onboard controls are further configured to:
provide the function of selecting still images from the video data stream;
adjust light source intensity; and
relay control signals to the optical imaging system.

30. The system of claim 29, wherein the onboard embedded system executes a detection software module configured to:
process and store information in real-time;
display the video data stream in real-time;
store inspection data as the still images to be captured from the video stream;
record a location at which the still images are captured, relative to the coated substrate under inspection;
automate reporting of inspection findings;
maintain a database of the still images captured and associated data;
store user instructions for reference;
monitor system messages and status; and
communicate with external peripherals.

31. The system of claim 27, wherein an external computing system communicates with the embedded system and serves to duplicate all onboard controls and mirror real-time displays remotely.

32. The system of claim 31, wherein the external computing system is a tablet, laptop or desktop computer using the wired or wireless communication with the embedded system.

33. The system of claim 30, wherein the video data stream, detection software module and image data are viewed remotely using the wearable head-up display (HUD), in wired or wireless communication with the embedded system.

34. The system of claim 30, wherein the detection software module is configured to monitor and display battery and system voltages of the battery and power management system

35. The system of claim 27, wherein the onboard battery is a replaceable or rechargeable battery.

36. The system of claim 21, wherein the optical imaging system comprises:
a focal plane array;
a lens; and
a flat optical window.

37. The system of claim 36, wherein the lens is compatible with MWIR light and configured to create an image of the coated substrate on the focal plane array.

38. A detection method performed by a detection system, comprising:
initiating the detection software module;
powering up the detection device and the optical imaging system;
connecting an optional heads-up display;
enabling the light source array;
collecting, and processing the video data stream in real-time to reveal an image of structural features including any abnormalities in the substrate;
capturing still frames and meta-data via onboard, HUD or external computing system controls.
